(19) United States
(12) Patent Application Publication
(10) Pub. No.: US 2009/0077612 A1
(43) Pub. Date: Mar. 19, 2009

(54) Television Box with Photo Display Function

(75) Inventors: Kao-Yi Shen, Chung Ho City (TW); Yung-Da Lin, Chung Ho City (TW); Ming-Yao Lu, Chung Ho City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AVERMEDIA TECHNOLOGIES, INC., Chung Ho City (TW)

(21) Appl. No.: 11/951,695

(22) Filed: Dec. 6, 2007

(30) Foreign Application Priority Data
Sep. 13, 2007 (TW) 96215402

(51) Int. Cl. H04N 7/173

(52) U.S. Cl. 725/134

(57) ABSTRACT

The TV box with digital photo display function includes a signal receiver for receiving a television signal, a video decoder connected with the signal receiver, a memory slot for receiving a removable memory, a photo decoder connected with memory slot, a processor, and a transmitting interface. The television signal received by the signal receiver is transmitted to the video decoder and is decoded. An image data stored in the removable memory is transmitted to the photo decoder through the memory slot. The processor may process the decoded television signal or the decoded image data, and the television signal or the image data can be transmitted to an external display through the transmitting interface.

### RELATED APPLICATIONS

This application claims priority to Taiwan Application Serial Number 96215402, filed Sep. 13, 2007, which is herein incorporated by reference.

### BACKGROUND

1. Field of Invention

The present invention relates to a television box. More particularly, the present invention relates to a television box with digital photo display function.

2. Description of Related Art

Computers and their peripherals have become very popular in recent years. The functions and varieties of peripheral with computers have greatly increased. For example, using a computer to receive and display TV signals has become a popular computer application. Once a television box (TV box) is applied to a computer, cable or wireless TV program signals can be transformed into signals that can be displayed by a computer such that a computer user does not have to buy an extra TV for watching TV programs.

With the rapid development of digital image processing technology and the wide use of digital cameras, digital media players have become important in the consumer electronic product market. The digital media player may display the digital photo without developing films. The digital media player may also display the digital photo continuously.

### SUMMARY

The invention provides a television box with digital photo display function. The TV box with digital photo display function includes a signal receiver for receiving a television signal, a video decoder connected with the signal receiver, a memory slot for receiving a removable memory, a photo decoder connected with memory slot, a processor, and a transmitting interface. The television signal received by the signal receiver is transmitted to the video decoder and is decoded. An image data stored in the removable memory is transmitted to the photo decoder through the memory slot. The processor may process the decoded television signal or the decoded image data, and the television signal or the image data can be transmitted to an external display through the transmitting interface.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of an embodiment of the television box with digital photo display function of the invention;

FIG. 2 is a block diagram of an embodiment of the television box with digital photo display function of the invention; and.

FIG. 3 is a block diagram of another embodiment of the television box with digital photo display function of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

For convenient use of the television box, users can socket the television boxes on the display and watch television programs without installing a program or opening the computer. Also, consumer electronic products tend to integrate various functions to fit a customer's requirement. The present invention provides a television box (TV box) with digital photo display function, which integrates a TV box and a digital photo frame.

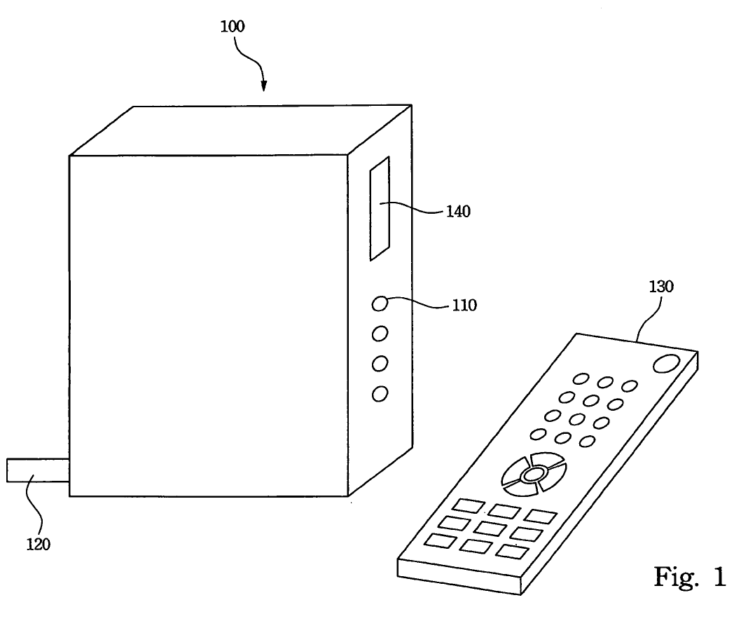

Refer to FIG. 1. FIG. 1 illustrates a schematic diagram of an embodiment of the television box with digital photo display function of the invention. The TV box 100 includes several terminal sockets 110, a transmitting interface 120, a remote control 130, and a memory slot 140. A removable memory (not shown) could be received in the memory slot 140, and an image data stored in the removable memory can be transmitted to the TV box 100 through the memory slot 140 and be processed. The processed image data in the TV box 100 can be transmitted to an external display through the transmitting interface 120.

The removable memory may be a flash memory card, such as a multi media card (MMC), a secured digital card (SD card), a compact flash card (CF card), or a memory stick (MS). The type of the memory slot 140 may be the same as the memory device. The compatibility between the memory slot 140 and the removable memory may be expanded by adding a card reader.

The TV box 100 with digital photo display function is connected to the external display, and the transmitting interface 120 can be a video graphics array (VGA). The TV box 100 may be a digital TV box, an analog TV box, a Hybrid TV box, or a dual TV box. The received TV signal can be a digital TV signal or an analog TV signal.

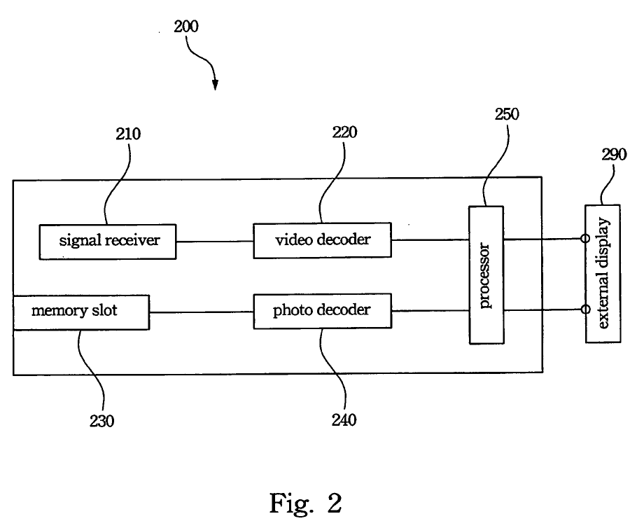

Refer to FIG. 2. FIG. 2 illustrates a block diagram of an embodiment of the television box with digital photo display function of the invention. The TV box 200 includes a signal receiver 210, a video decoder 220, a memory slot 230, a photo decoder 240, and a processor 250. The signal receiver 210 can receive the TV signal and the TV signal is transmitted to the video decoder 220 to be decoded and transferred to a video signal, such as a MPEG 2 video signal, a MPEG 4 signal, or other standard video signal. The decoded TV signal is further transmitted to the processor 250 to be image processed and is transmitted to the external display 290 for displaying.

The image data stored in the removable memory can be a digital photo or a video film. The image data can be transmitted to the photo decoder 240 via the memory slot 230 to transfer the image data into a displaying style. Then, the decoded image data can be transmitted to the processor 250 for image processing and is shown on the external display.

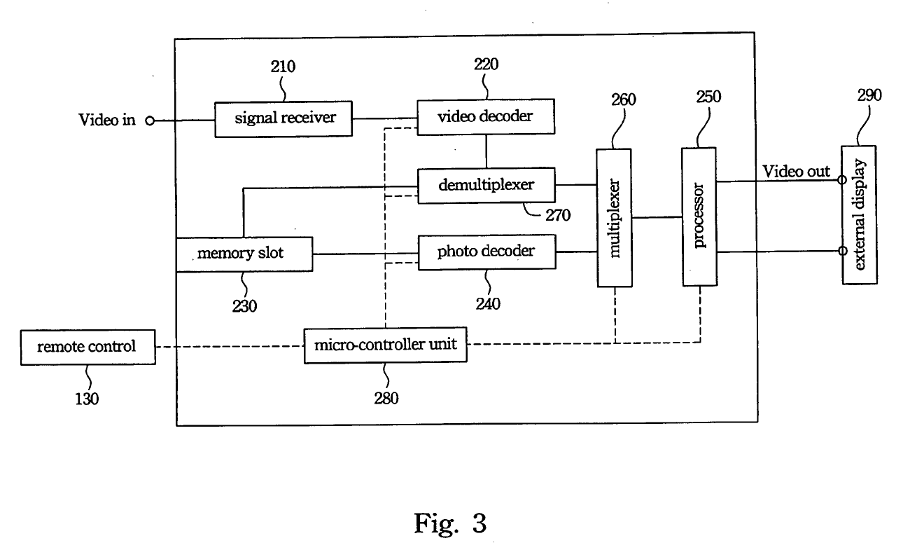

Refer to FIG. 3. FIG. 3 illustrates a block diagram of another embodiment of the television box with digital photo display function of the invention. The TV box 200 with digital photo display function may further include a multiplexer 260, a demultiplexer 270, and a micro-controller unit (MCU) 280. The TV signal decoded by the video decoder 220 can be transmitted to the demultiplxer 270. The TV signal is further sent to the processor 250 for display on the external display 290, or sent to the memory slot 230 for storing in the removable memory, or sent both to the processor 250 and the memory slot 230. Thus, the TV program can be displayed on the external display and stored in the removable memory simultaneously without opening the computer.

The TV signal decoded by the video decoder 220 and the image data decoded by the photo decoder 240 are transmitted to the multiplexer 260 for selection. One of the TV signal and the image data can be sent to the processor 250 for processing to be shown on the external display 290. The micro-controller unit 280 in the TV box 200 may receive a control signal sent from the remote control 130 (shown in FIG. 1) for controlling the video decoder 220, the photo decoder 240, the processor 250, the multiplexer 260, and the demultiplexer 270. The signal receiver 210 may further include a tuner for tuning the high frequency TV signal into the decodable TV signal, which is further transmitted to the video decoder 220.

The TV box with digital photo display function could display the TV program and the digital photo on the external display without opening the computer, and the TV program can also store the TV program in the removable memory received in the memory slot.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A television box with digital photo display function comprising:
a signal receiver for receiving a television signal;
a video decoder connected with the signal receiver, wherein the television signal is transmitted to the video decoder;
a memory slot for receiving a removable memory;
a photo decoder connected with memory slot, wherein an image data is transmitted to the photo decoder through the memory slot;
a processor for processing the decoded television signal or the decoded image data; and
a transmitting interface for transmitting the television signal or the image data to an external display.

2. The television box with digital photo display function of claim 1, further comprising a multiplexer, wherein the television signal and the image data are transmitted to the multiplexer and are selected by the multiplexer, and the television signal or the image data is further transmitted to the processor.

3. The television box with digital photo display function of claim 2, further comprising a demultiplexer connected to the video decoder, wherein the decoded television signal is transmitted to the demultiplexer.

4. The television box with digital photo display function of claim 3, wherein the decoded television signal from the demultiplexer is transmitted to the multiplexer.

5. The television box with digital photo display function of claim 3, wherein the decoded television signal from the demultiplexer is transmitted to the removable memory received in the memory slot, and the television signal is stored in the removable memory.

6. The television box with digital photo display function of claim 3, further comprising a remote control and a micro-controller unit disposed in the television box, wherein the remote control sends a control signal to the micro controller for controlling the video decoder, the photo decoder, the multiplexer, the demultiplexer, and the processor.

7. The television box with digital photo display function of claim 1, wherein the removable memory is a flash memory card.

8. The television box with digital photo display function of claim 1, wherein the signal receiver comprises a tuner for tuning the television signal, which is further transmitted to the video decoder.

9. The television box with digital photo display function of claim 1, wherein the television box is socketed on the external display.
